(19) United States
(12) Patent Application Publication
(10) Pub. No.: US 2024/0140334 A1
(43) Pub. Date: May 2, 2024

(54) VEHICLE COMMUNICATION DEVICE AND DISPLAY APPARATUS FOR VEHICLE INCLUDING THE SAME

(71) Applicant: LG Electronics Inc., Seoul (KR)

(72) Inventors: Sehwan PARK, Seoul (KR); Namyong PARK, Seoul (KR); Jungbae KIM, Seoul (KR); Gyujin KIM, Seoul (KR); Jingu PARK, Seoul (KR)

(21) Appl. No.: 18/278,337

(22) PCT Filed: Dec. 3, 2021
(86) PCT No.: PCT/KR2021/018251

§ 371 Date: Aug. 22, 2023

(51) Int. Cl. B60R 16/023; G06F 3/14; G06F 9/455; H04L 67/12; H04W 4/40

(52) U.S. Cl. CPC B60R 16/023; G06F 3/1431; G06F 9/45558; H04L 67/12; H04W 4/40; G06F 2009/45583

(57) ABSTRACT

Disclosed is a vehicle communication device including a plurality of communication modules disposed at a plurality of areas of a vehicle, the plurality of communication modules being configured to receive signals from a plurality of sensor devices mounted to the vehicle, and a signal processing device disposed between the areas of the vehicle, wherein each communication module includes a first connector configured to receive signals from some of the plurality of sensor devices at a first communication speed, a second connector configured to communicate with the signal processing device at a second communication speed, and an Ethernet switch configured to perform switching. Accordingly, wiring harnesses between the plurality of sensor devices and the signal processing device may be simply implemented.

### TECHNICAL FIELD

The present disclosure relates to a vehicle communication device and a display apparatus for vehicle including the same, and more particularly, to a display apparatus for vehicle implemented with wiring harnesses between a plurality of sensor devices and a signal processing device.

### BACKGROUND

A vehicle is an apparatus that a driver moves in a desired direction. A representative example of the vehicle is a car.

In some implementations, a plurality of sensor devices and a display apparatus for vehicle is mounted at various positions in the vehicle for convenience of users who use the vehicle.

In some implementations, wiring harnesses can be used to transmit signals sensed by the plurality of sensor devices in the vehicle to a signal processing device.

When the number of sensor devices is increased, however, the length of the wiring harnesses can also be increased, whereby wiring can be complicated.

### SUMMARY

The present disclosure is directed to a display apparatus for vehicle capable of simply implementing wiring harnesses between a plurality of sensor devices and a signal processing device.

The present disclosure is also directed to a display apparatus for vehicle capable of performing high-speed data communication between a plurality of virtual machines.

The present disclosure is also directed to a display apparatus for vehicle capable of performing high-speed data communication even though a plurality of virtual machines is driven by different operating systems.

According to one aspect of the subject matter described in this application, a vehicle communication device can include a plurality of communication modules configured to be disposed at a plurality of areas of a vehicle and further configured to (i) receive, from a plurality of sensor devices configured to be disposed at the plurality of areas of the vehicle, one or more signals and (ii) transmit one or more signals of the received one or more signals to an outside of the plurality of communication modules, and a signal processing device configured to be disposed between the plurality of areas of the vehicle and further configured to receive a signal from the plurality of communication modules and perform signal processing. Each communication module among the plurality of communication modules can include a first connector configured to receive one or more signals from one or more devices among the plurality of sensor devices at a first communication speed, a second connector configured to communicate with the signal processing device at a second communication speed greater than the first communication speed, and a first switch disposed between the first connector and the second connector and configured to perform switching between the first connector and the second connector.

Implementations according to this aspect can include one or more of the following features. For example, the each communication module can further include a processor electrically connected to the first switch, and the processor can be configured to process the one or more signals from the sensor devices and transmit the processed one or more signals to the signal processing device via the second connector.

In some implementations, the each communication module can be configured to transmit, to the signal processing device, one or more signals from one or more sensor devices disposed at each area corresponding to the each communication module among the plurality of areas. In some implementations, the signal processing device can include a second switch configured to be operated based on the second communication speed, the second switch can be configured to be operated as a master device, and the first switch in the each communication module can be configured to be operated as a slave device based on the first communication speed or the second communication speed.

In some examples, the first connector can be configured to perform serial communication, and the second connector can be configured to perform parallel communication. In some examples, the plurality of communication modules can include a first communication module configured to receive, from one or more first sensor devices disposed in a first area among the plurality of areas, one or more first signals and transmit the one or more first signals to the signal processing device, and a second communication module configured to receive, from one or more second sensor devices disposed in a second area among the plurality of areas, one or more second signals and transmit the one or more second signals to the signal processing device.

In some implementations, the plurality of communication modules can include a first communication module configured to receive, from one or more first sensor devices disposed in a first area among the plurality of areas, one or more first signals and transmit the one or more first signals to the signal processing device, a second communication module configured to receive, from one or more second sensor devices disposed in a second area among the plurality of areas, one or more second signals and transmit the one or more second signals to the signal processing device, a third communication module configured to receive, from one or more third sensor devices disposed in a third area among the plurality of areas, one or more third signals and transmit the one or more third signals to the signal processing device, and a fourth communication module configured to receive, from one or more fourth sensor devices disposed in a fourth area among the plurality of areas, one or more fourth signals and transmit the one or more fourth signals to the signal processing device.

In some examples, the each communication module can be configured to output a vehicle control signal for controlling a door and a seat of the vehicle while the vehicle travels. In some examples, each of the plurality of sensor devices can include a camera, a lidar, a radar, or a position sensor.

In some implementations, the signal processing device can include a processor configured to perform signal processing for a first display and a second display that are configured to be located in the vehicle, the processor can be configured to execute first, second, and third virtual machines on a hypervisor in the processor, the second virtual machine can be configured to be operated for the first display, the third virtual machine can be configured to be operated for the second display, and the first virtual machine can be configured to set a shared memory based on the hypervisor for transmission of data to the second virtual machine and the third virtual machine. In some examples, the first virtual machine can be configured to set the shared memory based on the hypervisor for transmission of same data to the second virtual machine and the third virtual machine.

In some examples, the first virtual machine can be configured to transmit, to the second virtual machine and the third virtual machine, information regarding the shared memory comprising key data for data access after setting the shared memory. In some examples, the first virtual machine can include an input and output server interface and a security manager, and each of the second virtual machine and the third virtual machine can include an input and output client interface.

In some implementations, the security manager can be configured to allocate the shared memory, and the input and output client interface can be configured to transmit a request for connection to the input and output server interface after allocation of the shared memory. In some implementations, the input and output server interface can be configured to transmit information regarding the shared memory comprising key data for data access to the input and output client interface after allocation of the shared memory, and the input and output client interface can be configured to access the shared memory based on the key data.

In some examples, the input and output server interface can be configured to receive information regarding a first buffer in the shared memory, write, based on the first buffer being empty according to the received information regarding the first buffer, first data in the first buffer in the shared memory, and transmit buffer information of the first buffer to the input and output client interfaces in the second virtual machine and the third virtual machine. In some examples, the first virtual machine can be configured to receive vehicle sensor data, position information data, or camera image data from at least one of the plurality of communication modules, process the received data, and provide the processed data to the second virtual machine or the third virtual machine.

In some implementations, the first virtual machine can be configured to receive wheel speed sensor data of the vehicle from at least one of the plurality of communication modules, process the received wheel speed sensor data, and transmit the processed wheel speed sensor data to at least one of the second virtual machine or the third virtual machine.

According to another aspect of the subject matter described in this application, a vehicle communication device can include a plurality of communication modules configured to be disposed at a plurality of areas of a vehicle and further configured to receive, from a plurality of sensor devices configured to be disposed at the plurality of areas of the vehicle, one or more signals and transmit one or more signals of the received one or more signals to an outside of the plurality of communication modules. Each communication module among the plurality of communication modules can include a first connector configured to receive one or more signals from the plurality of sensor devices at a first communication speed, a second connector configured to communicate with one of the plurality of communication modules adjacent thereto at a second communication speed greater than the first communication speed, and a switch disposed between the first connector and the second connector and configured to perform switching between the first connector and the second connector.

According to another aspect of the subject matter described in this application, a display apparatus for a vehicle can include a first display, a second display, and a vehicle communication device comprising (i) a signal processing device that includes a processor configured to perform signal processing for the first display and the second display and (ii) a plurality of communication modules configured to be disposed at a plurality of areas of the vehicle and further configured to receive, from a plurality of sensor devices configured to be disposed at the plurality of areas of the vehicle, one or more signals and transmit one or more signals of the received one or more signals to an outside of the plurality of communication modules. The signal processing device can be configured to be disposed between the plurality of areas and further configured to receive one or more signals from the plurality of communication modules and perform signal processing. Each communication module among the plurality of communication modules can include a first connector configured to receive one or more signals from one or more sensor devices among the plurality of sensor devices at a first communication speed, a second connector configured to communicate with the signal processing device at a second communication speed greater than the first communication speed, and a switch disposed between the first connector and the second connector and configured to perform switching between the first connector and the second connector.

### BRIEF DESCRIPTION OF THE DRAWINGS

FIG. 1 is a diagram illustrating an example of the exterior and interior of a vehicle.

FIG. 2 is a diagram illustrating an example of disposition of a vehicle communication device in a vehicle.

FIG. 3 is a diagram illustrating another example of disposition of a vehicle communication device in a vehicle.

FIG. 4 is a diagram illustrating another example of disposition of a vehicle communication device in a vehicle.

FIGS. 5A and 5B are diagrams referred to in the description of FIG. 4.

FIG. 6 is a diagram illustrating another example of disposition of a vehicle communication device in a vehicle.

FIG. 7A is a diagram illustrating another example of the interior of the vehicle.

FIG. 7B is a diagram illustrating an example of an external appearance of a display apparatus for vehicle.

FIG. 8 is a diagram illustrating an example of an internal block diagram of the display apparatus for vehicle of FIG. 7B.

FIG. 9 is a diagram illustrating an example of a system driven in a signal processing device.

FIG. 10 is a diagram illustrating another example of a system driven in a signal processing device.

FIG. 11 is a diagram referred to in the description of operation of the system driven in the signal processing device.

FIGS. 12A-B, 13, 14A-B, 15, 16, 17A-C, 18, 19, and 20 are diagrams referred to in the description of FIG. 10 or 11.

### DETAILED DESCRIPTION

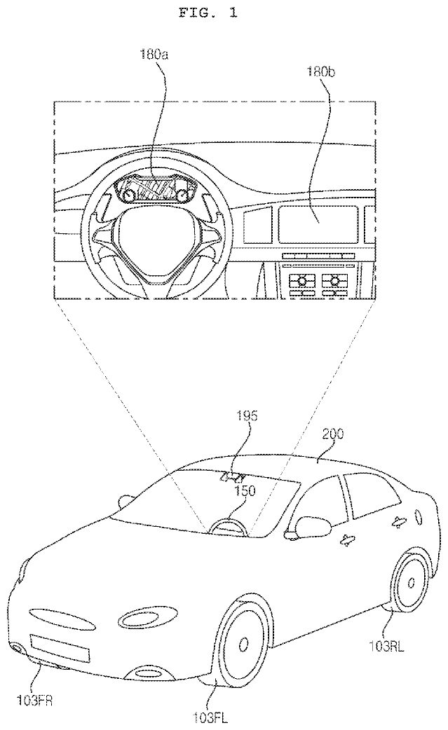

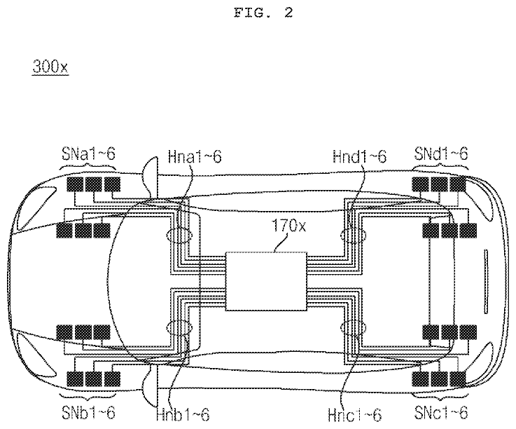

FIG. 1 is a diagram illustrating an example of the exterior and interior of a vehicle.

Referring to the figure, the vehicle 200 can be moved by a plurality of wheels 103FR, 103FL, 103RL, . . . rotated by a power source and a steering wheel 150 configured to adjust an advancing direction of the vehicle 200.

In some implementations, the vehicle 200 can be provided with a camera 195 configured to acquire an image of the front of the vehicle.

In some implementations, the vehicle 200 can be further provided therein with a plurality of displays 180a and 180b configured to display images and information.

In FIG. 1, a cluster display 180a and an audio video navigation (AVN) display 180b can be illustrated as the plurality of displays 180a and 180b. In addition, a head up display (HUD) can also be used.

In some implementations, the audio video navigation (AVN) display 180b can also be called a center information display.

In some implementations, in a display apparatus 100 for vehicle including a plurality of displays 180a and 180b, the plurality of displays 180a and 180b can display the same images in a synchronized state.

In particular, a signal processing device 170 in the display apparatus 100 for vehicle can transmit the same data to a plurality of virtual machines in a synchronized state, and can be configured to display the same images on the displays. This will be described with reference to FIG. 10 and subsequent figures.

In some implementations, the vehicle 200 described in this specification can be a concept including all of a vehicle having an engine as a power source, a hybrid vehicle having an engine and an electric motor as a power source, and an electric vehicle having an electric motor as a power source.

FIG. 2 is a diagram illustrating an example of disposition of a vehicle communication device in a vehicle.

Referring to the figure, the vehicle communication device 300x in the vehicle can include a plurality of sensor devices SNa1 to SNd6 mounted to the vehicle 200 and a signal processing device 170x configured to receive signals from the plurality of sensor devices SNa1 to SNd6.

The figure illustrates that, among the plurality of sensor devices SNa1 to SNd6, the sensor devices SNa1 to SNa6 can be located in a first area at a right front of the vehicle in the vehicle, the sensor devices SNb1 to SNb6 can be located in a second area at a left front of the vehicle in the vehicle, the sensor devices SNc1 to SNc6 can be located in a third area at a left rear of the vehicle in the vehicle, and the sensor devices SNd1 to SNd6 can be located in a fourth area at a right rear of the vehicle in the vehicle.

In some implementations, in the vehicle communication device 300x in the vehicle of FIG. 2, wiring harnesses HNa1 to HNd6 can be disposed between the plurality of sensor devices SNa1 to SNd6 and the signal processing device 170x to transmit signals from the plurality of sensor devices SNa1 to SNd6.

The figure illustrates that the wiring harnesses HNa1 to HNa6 can be connected to the sensor devices SNa1 to SNa6 in the first area at the right front of the vehicle in the vehicle, the wiring harnesses HNb1 to HNb6 can be connected to the sensor devices SNb1 to SNb6 in the second area at the left front of the vehicle in the vehicle, the wiring harnesses HNc1 to HNc6 can be connected to the sensor devices SNc1 to SNc6 in the third area at the left rear of the vehicle in the vehicle, and the wiring harnesses HNd1 to HNd6 can be connected to the sensor devices SNd1 to SNd6 in the fourth area at the right rear of the vehicle in the vehicle.

In response to the number of sensor devices being increased, however, the length of the wiring harnesses HNa1 to HNd6 may also be increased, whereby wiring can be complicated.

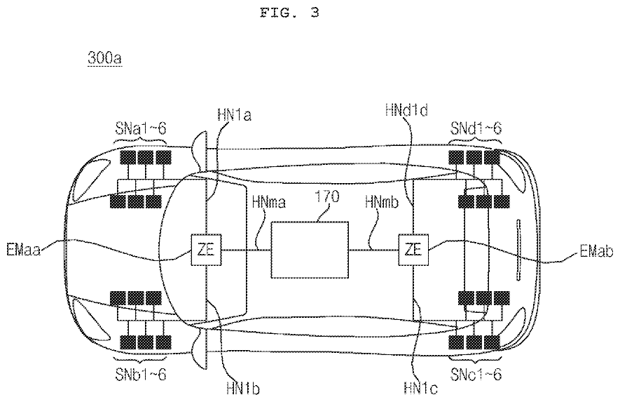

Consequently, the present disclosure proposes a scheme capable of simply implementing a wiring harness through reduction in length of the wiring harness. This will be described with reference to FIG. 3 and subsequent figures.

FIG. 3 is a diagram illustrating another example of disposition of a vehicle communication device in a vehicle.

Referring to the figure, the vehicle communication device 300a can include a plurality of communication modules EMaa and EMab disposed at a plurality of areas of the vehicle 200, where the plurality of communication modules EMaa and EMab can be configured to receive signals from a plurality of sensor devices SNa1 to SNd6 mounted to the vehicle 200 to be disposed at the plurality of areas of the vehicle 200 and to transmit at least some of the received signals to the outside of the plurality of communication modules, and a signal processing device 170 disposed between the plurality of areas of the vehicle 200 and configured to receive signals from the plurality of communication modules EMaa and EMab and to perform signal processing.

In some implementations, the plurality of communication modules EMaa and EMab can include a first communication module EMaa configured to receive signals from the sensor devices SNa1 to SNb6 disposed in a first area of the vehicle 200, among the plurality of sensor devices SNa1 to SNd6, and to transmit the signals to the signal processing device 170, and a second communication module EMab configured to receive signals from the sensor devices SNc1 to SNd6 disposed in a second area of the vehicle 200, among the plurality of sensor devices SNa1 to SNd6, and to transmit the signals to the signal processing device 170.

In particular, the vehicle communication device 300a of FIG. 3 can include a first communication module EMaa disposed at a front of the vehicle in the vehicle, a second communication module EMab disposed at a rear of the vehicle in the vehicle, and a signal processing device 170 configured to receive signals from the first communication module EMaa and the second communication module EMab.

In some implementations, the first communication module EMaa of FIG. 3 can be connected to the sensor devices SNa1 to SNa6 disposed in the first area at the right front of the vehicle in the vehicle, among the plurality of sensor devices SNa1 to SNd6, via a wiring harness HN1a, and can be connected to the sensor devices SNb1 to SNb6 disposed in the second area at the left front of the vehicle in the vehicle, among the plurality of sensor devices SNa1 to SNd6, via a wiring harness HN1b.

In some implementations, the second communication module EMab of FIG. 3 can be connected to the sensor devices SNc1 to SNc6 disposed in the third area at the left rear of the vehicle in the vehicle, among the plurality of sensor devices SNa1 to SNd6, via a wiring harness HN1c, and can be connected to the sensor devices SNd1 to SNd6 disposed in the fourth area at the right rear of the vehicle in the vehicle, among the plurality of sensor devices SNa1 to SNd6, via a wiring harness HN1d.

In some implementations, the first communication module EMaa and the signal processing device 170 can be connected to each other via a wiring harness HNma, and the second communication module EMab and the signal processing device 170 can be connected to each other via a wiring harness HNmb.

In the vehicle communication device 300a of FIG. 3, the plurality of sensor devices SNa1 to SNd6 in the vehicle can be divided to be disposed at a plurality of areas or zones, and each communication module is disposed to correspond to specific ones of the plurality of areas or zones, whereby the number and wiring length of wiring harnesses can be reduced, compared to FIG. 2. For example, the wiring harnesses between the plurality of sensor devices SNa1 to SNd6 and the signal processing device 170 can be simply implemented. In addition, efficient and stable data communication can be achieved by reducing the number and wiring length of the wiring harness.

In some implementations, each of the communication modules EMaa and EMab can output a vehicle control signal for door control and seat control while the vehicle 200 is traveling. Consequently, vehicle control through each of the communication modules EMaa and EMab can be achieved.

In some implementations, each of the plurality of sensor devices SNa1 to SNd6 can include a camera, a lidar, a radar, or a position sensor. Consequently, signals from various kinds of sensor devices can be efficiently and stably transmitted to the signal processing device 170.

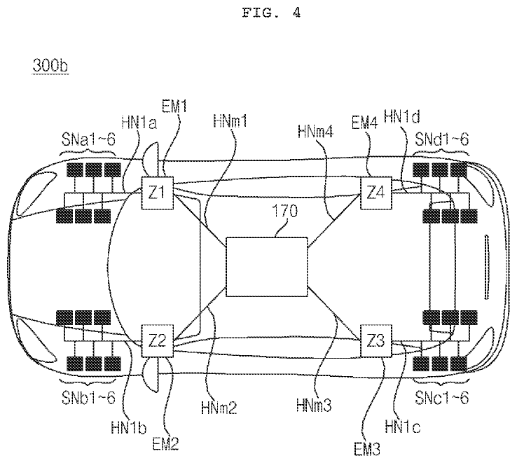

FIG. 4 is a diagram illustrating another example of disposition of a vehicle communication device in a vehicle.

Referring to the figure, the vehicle communication device 300b can include a plurality of communication modules EM1 to EM4 disposed at a plurality of areas of the vehicle 200, where the plurality of communication modules EM1 to EM4 can be configured to receive signals from a plurality of sensor devices SNa1 to SNd6 mounted to the vehicle 200 to be disposed at the plurality of areas of the vehicle 200 and to transmit at least some of the received signals to the outside, and a signal processing device 170 disposed between the plurality of areas of the vehicle 200 and configured to receive signals from the plurality of communication modules EM1 to EM4 and to perform signal processing.

In some implementations, the plurality of communication modules EM1 to EM4 can include a first communication module EM1 configured to receive signals from the sensor devices SNa1 to SNa6 disposed in the first area of the vehicle 200, among the plurality of sensor devices SNa1 to SNd6, and to transmit the signals to the signal processing device 170, a second communication module EM2 configured to receive signals from the sensor devices SNb1 to SNb6 disposed in the second area of the vehicle 200, among the plurality of sensor devices SNa1 to SNd6, and to transmit the signals to the signal processing device 170, a third communication module EM3 configured to receive signals from the sensor devices SNc1 to SNc6 disposed in the third area of the vehicle 200, among the plurality of sensor devices SNa1 to SNd6, and to transmit the signals to the signal processing device 170, and a fourth communication module EM4 configured to receive signals from the sensor devices SNd1 to SNd6 disposed in the fourth area of the vehicle 200, among the plurality of sensor devices SNa1 to SNd6, and to transmit the signals to the signal processing device 170.

In particular, the vehicle communication device 300b of FIG. 4 can include a first communication module EM1 disposed at the right front of the vehicle in the vehicle, a second communication module EM2 disposed at the left front of the vehicle in the vehicle, a third communication module EM3 disposed at the left rear of the vehicle in the vehicle, a fourth communication module EM4 disposed at the right rear of the vehicle in the vehicle, and a signal processing device 170 configured to receive signals from the communication modules EM1 to EM4.

In some implementations, the first communication module EM1 of FIG. 4 is connected to the sensor devices SNa1 to SNa6 disposed in the first area at the right front of the vehicle in the vehicle, among the plurality of sensor devices SNa1 to SNd6, via a wiring harness HN1a.

In some implementations, the second communication module EM2 is connected to the sensor devices SNb1 to SNb6 disposed in the second area at the left front of the vehicle in the vehicle via a wiring harness HN1b.

In some implementations, the third communication module EM3 is connected to the sensor devices SNc1 to SNc6 disposed in the third area at the left rear of the vehicle in the vehicle, among the plurality of sensor devices SNa1 to SNd6, via a wiring harness HN1c.

In some implementations, the fourth communication module EM4 is connected to the sensor devices SNd1 to SNd6 disposed in the fourth area at the right rear of the vehicle in the vehicle via a wiring harness HN1d.

In some implementations, the first communication module EM1 and the signal processing device 170 are connected to each other via a wiring harness HNm1, the second communication module EM2 and the signal processing device 170 are connected to each other via a wiring harness HNm2, the third communication module EM3 and the signal processing device 170 are connected to each other via a wiring harness HNm3, and the fourth communication module EM4 and the signal processing device 170 are connected to each other via a wiring harness HNm4.

In the vehicle communication device 300b of FIG. 4, the plurality of sensor devices SNa1 to SNd6 in the vehicle can be divided to be disposed at four areas or zones, and each communication module is disposed to correspond to a specific one of the plurality of areas or zones, whereby the number and wiring length of wiring harnesses can be reduced. For example, the wiring harnesses between the plurality of sensor devices SNa1 to SNd6 and the signal processing device 170 can be simply implemented. In addition, efficient and stable data communication can be achieved.

In some implementations, each of the plurality of sensor devices SNa1 to SNd6 can include a camera, a lidar, a radar, or a position sensor. Consequently, signals from various kinds of sensor devices can be efficiently and stably transmitted to the signal processing device 170.

In some implementations, each of the communication modules EM1 to EM4 can output a vehicle control signal for door control and seat control while the vehicle 200 travels. Consequently, vehicle control through each of the communication modules EM1 to EM4 can be achieved.

In some implementations, the communication modules EM1 to EM4 can transmit signals from the sensor devices SNa1 to SNd6 disposed at the plurality of areas of the vehicle 200 to the signal processing device 170. Consequently, efficient and stable data communication can be achieved.

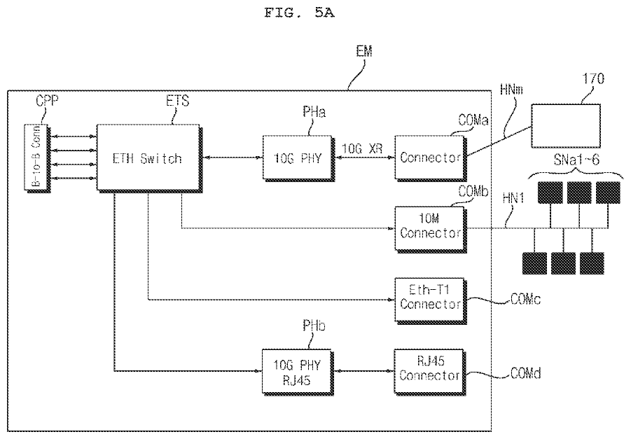

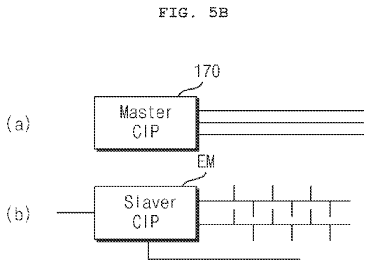

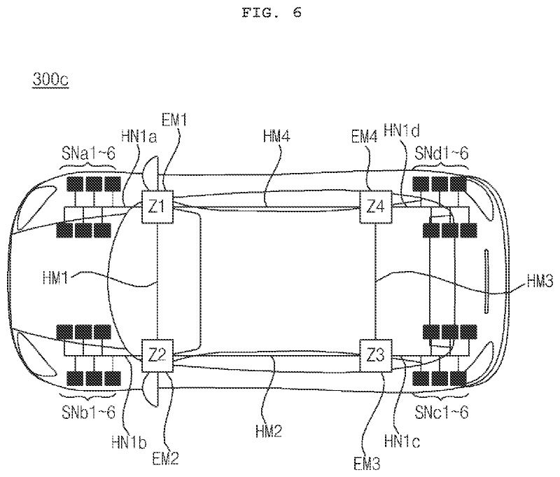

FIGS. 5A and 5B are diagrams referred to in the description of FIG. 4.

FIG. 5A is an example of an internal block diagram of each communication module of FIG. 3 or 4.

Each communication module EM can include a first connector COMa configured to receive signals from some of the plurality of sensor devices SNa1 to SNd6 at a first communication speed, a second connector COMb configured to communicate with the signal processing device 170 at a second communication speed greater than the first communication speed, and an Ethernet switch ETS disposed between the first connector COMa and the second connector COMb and configured to perform switching between connectors.

Since the plurality of communication modules EM1 to EM4 are disposed for respective areas, as described above, the wiring harnesses between the plurality of sensor devices SNa1 to SNd6 and the signal processing device 170 can be simply implemented. In addition, Ethernet, which is a public communication protocol, can be used, whereby efficient and stable data communication can be achieved.

In some implementations, the Ethernet switch ETS is capable of performing communication from 10 M to 10 G, and a multi-connector can be used.

For example, the Ethernet switch ETS can perform PCIe communication for data communication with the signal processing device 170.

In some implementations, the Ethernet switch ETS can perform data communication based on 10Base-T1S for data communication with each sensor device.

In some implementations, the first connector COMa can perform serial communication, and the second connector COMb can perform parallel communication. Consequently, efficient and stable data communication can be achieved.

For example, the first connector COMa can be a high-speed connector for Ethernet communication based on 10GBase-T1. Consequently, a 10 GHz-based physical layer converter PHa can be disposed between the first connector COMa and the Ethernet switch ETS.

In some implementations, the second connector COMb can perform data communication based on 10Base-T1S.

In some implementations, each communication module EM can further include a third connector COMc for communication based on 1000Base-T1 and 100Base-T1 and a fourth connector COMd for communication based on 1000Base-T1. Consequently, a physical layer converter PHb can be disposed between the fourth connector COMd and the Ethernet switch ETS.

In some implementations, each communication module EM can further include a processor CPP electrically connected to the Ethernet switch ETS.

The processor CPP can process signals from the sensor devices SNa1 to SNd6 disposed at the plurality of areas of the vehicle 200, and can be configured to transmit the processed signals to the signal processing device 170 via the second connector COMb.

In some implementations, the processing speed or processing capacity of the processor CPP may be lower than the processing speed or processing capacity of the signal processing device 170.

FIG. 5B is a diagram illustrating a communication scheme between a master Ethernet device and a slave Ethernet device.

The figure illustrates that the signal processing device 170 can be operated as the master Ethernet device and the communication module EM can be operated as the slave Ethernet device.

The signal processing device 170, which is the master Ethernet device, can perform serial communication with the communication module EM, and the communication module EM, which is the slave Ethernet device, can perform parallel communication with each sensor device. Consequently, efficient and stable data communication can be achieved.

In some implementations, the signal processing device 170 can include an Ethernet switch ETS operated based on a second communication speed.

In some implementations, the Ethernet switch ETS in each of the communication modules EM1 to EM4 can perform communication based on a first communication speed or a second communication speed greater than the first communication speed.

FIG. 6 is a diagram illustrating another example of disposition of a vehicle communication device in a vehicle.

Referring to the figure, the vehicle communication device 300c can include a plurality of communication modules EM1 to EM4 disposed at a plurality of areas of the vehicle 200, where the plurality of communication modules EM1 to EM4 can be configured to receive signals from a plurality of sensor devices SNa1 to SNd6 mounted to the vehicle 200 to be disposed at the plurality of areas of the vehicle 200 and to transmit at least some of the received signals to the outside of the plurality of communication modules.

The vehicle communication device 300c of FIG. 6 can be similar to the vehicle communication device 300b of FIG. 4 except that the signal processing device 170 of FIG. 4 is omitted.

In the vehicle communication device 300c of FIG. 6, therefore, the first communication module EM1 and the second communication module EM2 can be connected to each other via a wiring harness HM1, the second communication module EM2 and the third communication module EM3 can be connected to each other via a wiring harness HM2, the third communication module EM3 and the fourth communication module EM4 can be connected to each other via a wiring harness HM3, and the fourth communication module EM4 and the first communication module EM1 can be connected to each other via a wiring harness HM4.

Consequently, each of the communication modules EM1 to EM4 can receive signals from corresponding ones of the sensor devices SNa1 to SNd6 disposed at the plurality of areas, and can transmit at least some of the received signals to a communication module adjacent thereto.

For example, each of the communication modules EM1 to EM4 includes a first connector COMa configured to receive signals from the plurality of sensor devices at a first communication speed, a second connector COMb configured to communicate with one of the communication modules adjacent thereto at a second communication speed greater than the first communication speed, and an Ethernet switch ETS disposed between the first connector COMa and the second connector COMb and configured to perform switching between the connectors.

In the vehicle communication device 300c of FIG. 6, the plurality of sensor devices SNa1 to SNd6 in the vehicle can be divided to be disposed at four areas or zones, and each communication module can be disposed to correspond to a specific one of the plurality of areas or zones, whereby the number and wiring length of wiring harnesses can be reduced.

In some implementations, each of the communication modules EM1 to EM4 can output a vehicle control signal for door control and seat control while the vehicle 200 travels. Consequently, vehicle control through each of the communication modules EM1 to EM4 can be achieved.

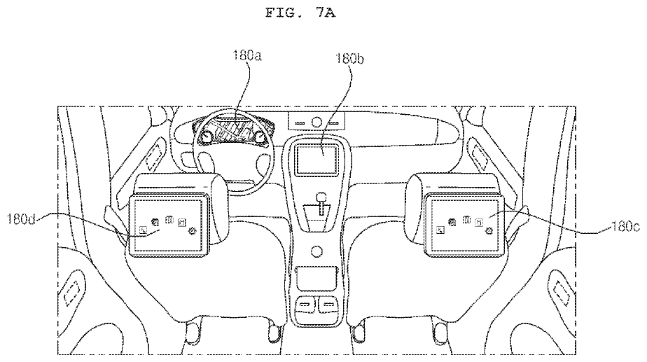

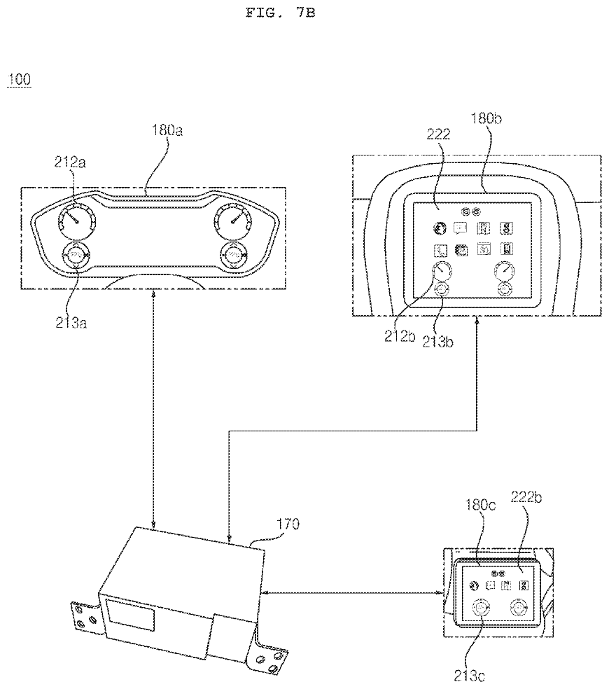

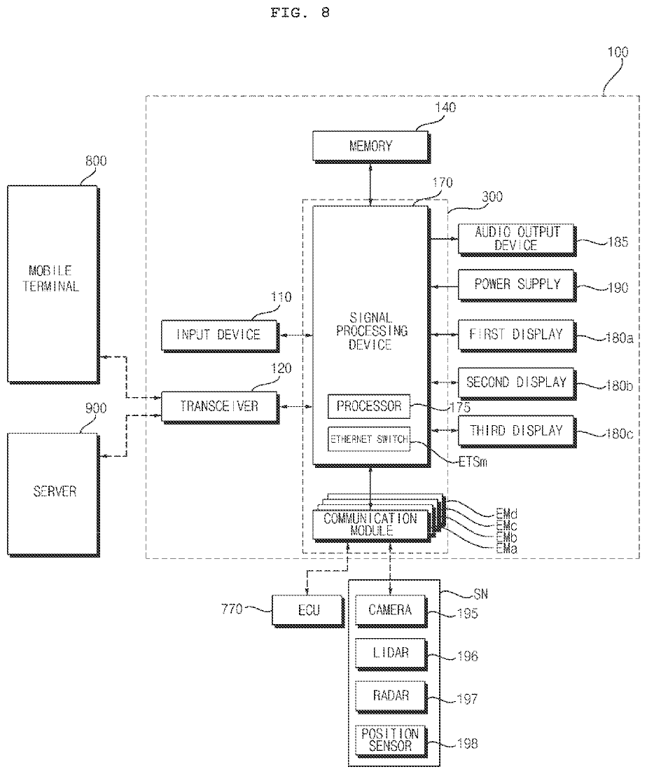

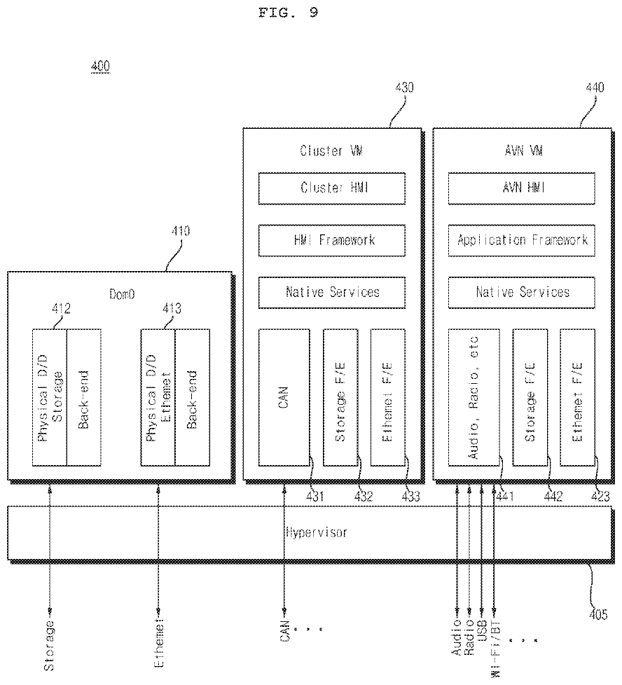

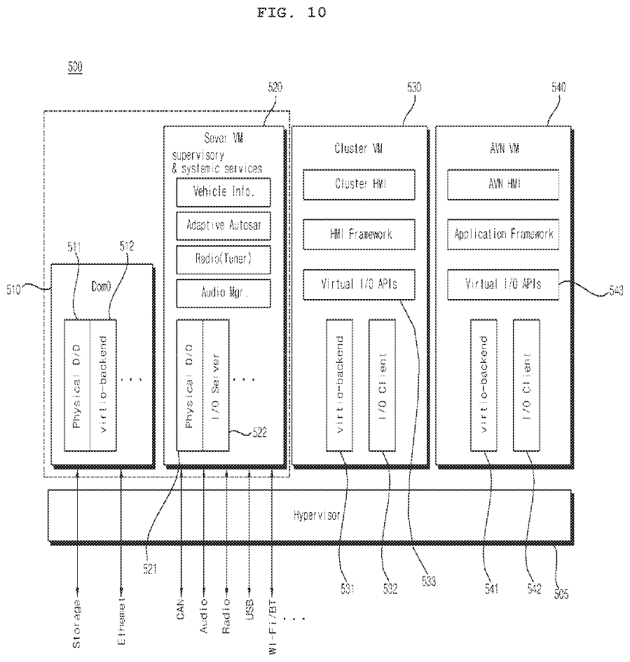

FIG. 7A is a diagram illustrating another example of the interior of the vehicle.

Referring to the figure, a cluster display 180a, an audio video navigation (AVN) display 180b, rear seat entertainment displays 180c and 180d, and a rear-view mirror display can be mounted in the vehicle.

The present disclosure proposes a scheme for a plurality of displays 180a to 180d constituting a display apparatus 100 for vehicle to display the same images in a synchronized state. This will be described with reference to FIG. 10 and subsequent figures.

FIG. 7B is a diagram illustrating an example of an external appearance of a display apparatus for vehicle.

The display apparatus 100 can include a plurality of displays 180a and 180b and a signal processing device 170 configured to perform signal processing to display images and information on the plurality of displays 180a and 180b.

The first display 180a, which is one of the plurality of displays 180a and 180b, can be a cluster display 180a configured to display a driving state and operation information, and the second display 180b can be an audio video navigation (AVN) display 180b configured to display vehicle driving information, a navigation map, various kinds of entertainment information, or an image.

The signal processing device 170 can have a processor 175 provided therein, and first to third virtual machines 520 to 540 can be executed by a hypervisor 505 in the processor 175.

The second virtual machine 530 can be operated for the first display 180a, and the third virtual machine 540 can be operated for the second display 180b.

In some implementations, the first virtual machine 520 in the processor 175 can be configured to set a shared memory 508 based on the hypervisor 505 for transmission of the same data to the second virtual machine 530 and the third virtual machine 540. Consequently, the first display 180a and the second display 180b in the vehicle can display the same information or the same images in a synchronized state.

In some implementations, the first virtual machine 520 in the processor 175 shares at least some of data with the second virtual machine 530 and the third virtual machine 540 for divided processing of data. Consequently, the plurality of virtual machines for the plurality of displays in the vehicle can divide and process data.

In some implementations, the first virtual machine 520 in the processor 175 can receive and process wheel speed sensor data of the vehicle, and can transmit the processed wheel speed sensor data to at least one of the second virtual machine 530 or the third virtual machine 540. Consequently, at least one virtual machine can share the wheel speed sensor data of the vehicle.

In some implementations, the display apparatus 100 for vehicle can further include a rear seat entertainment (RSE) display 180c configured to display driving state information, simple navigation information, various kinds of entertainment information, or an image.

The signal processing device 170 can further execute a fourth virtual machine, in addition to the first to third virtual machines 520 to 540, on the hypervisor 505 in the processor 175 to control the RSE display 180c.

Consequently, it is possible to control various displays 180a to 180c using a single signal processing device 170.

In some implementations, some of the plurality of displays 180a to 180c can be operated based on a Linux Operating System (OS), and others can be operated based on a Web Operating System (OS).

The signal processing device 170 can be configured to display the same information or the same images in a synchronized state on the displays 180a to 180c to be operated under various operating systems.

In some implementations, as depicted in FIG. 7B, a vehicle speed indicator 212a and an in-vehicle temperature indicator 213a can be displayed on the first display 180a, a home screen 222 including a plurality of applications, a vehicle speed indicator 212b, and an in-vehicle temperature indicator 213b can be displayed on the second display 180b, and a second home screen 222b including a plurality of applications and an in-vehicle temperature indicator 213c can be displayed on the third display 180c.

FIG. 8 is a diagram illustrating an example of an internal block diagram of the display apparatus for vehicle.

Referring to the figure, the display apparatus 100 can include an input device 110, a transceiver 120 for communication with an external device, a plurality of communication modules EMa to EMd for internal communication, a memory 140, a signal processing device 170, a plurality of displays 180a to 180c, an audio output device 185, and a power supply 190.

In some implementations, the vehicle communication device 300 can include the plurality of communication modules EMa to EMd and the signal processing device 170.

The signal processing device 170 can be provided therein with an Ethernet switch ETSm for data communication with each of the communication modules EM1 to EM4.

An Ethernet switch ETS in each of the communication modules EM1 to EM4 can be operated as a slave Ethernet device based on a first communication speed or a second communication speed, and the Ethernet switch ETSm in the signal processing device 170 can be operated as a master Ethernet device based on the second communication speed.

The communication modules EM1 to EM4 can perform data communication with the plurality of sensor devices SNa1 to SNd6.

In some implementations, each of the plurality of sensor devices SNa1 to SNd6 can include a camera 195, a lidar 196, a radar 197, or a position sensor 198.

The input device 110 can include a physical button or pad for button input or touch input.

In some implementations, the input device 110 can include a microphone configured to receive user voice.

The transceiver 120 can wirelessly exchange data with a mobile terminal 800 or a server 900.

In particular, the transceiver 120 can wirelessly exchange data with a mobile terminal of a vehicle driver. Any of various data communication schemes, such as Bluetooth, Wi-Fi, WIFI Direct, and APIX, can be used as a wireless data communication scheme.

The transceiver 120 can receive weather information and road traffic situation information, such as transport protocol expert group (TPEG) information, from the mobile terminal 800 or the server 900. For example, the transceiver 120 can include a mobile communication module.

The plurality of communication modules EM1 to EM4 can receive sensor information from an electronic control unit (ECU) 770 or a sensor device 760, and can transmit the received information to the signal processing device 170.

For example, the sensor information can include at least one of vehicle direction information, vehicle position information (global positioning system (GPS) information), vehicle angle information, vehicle velocity information, vehicle acceleration information, vehicle inclination information, vehicle forward/backward movement information, battery information, fuel information, tire information, vehicle lamp information, in-vehicle temperature information, or in-vehicle humidity information.

The sensor information can be acquired from a heading sensor, a yaw sensor, a gyro sensor, a position sensor, a vehicle forward/backward movement sensor, a wheel sensor, a vehicle velocity sensor, a car body inclination sensor, a battery sensor, a fuel sensor, a tire sensor, a steering-wheel-rotation-based steering sensor, an in-vehicle temperature sensor, or an in-vehicle humidity sensor.

In some implementations, the position module can include a GPS module configured to receive GPS information or a position sensor 198.

In some implementations, at least one of the plurality of communication modules EM1 to EM4 can transmit position information data sensed by the GPS module or the position sensor 198 to the signal processing device 170.

In some implementations, at least one of the plurality of communication modules EM1 to EM4 can receive front-of-vehicle image data, side-of-vehicle image data, rear-of-vehicle image data, and obstacle-around-vehicle distance information from the camera 195, the lidar 196, or the radar 197, and can transmit the received information to the signal processing device 170.

The memory 140 can store various data necessary for overall operation of the display apparatus 100 for vehicle, such as programs for processing or control of the signal processing device 170.

For example, the memory 140 can store data about the hypervisor and first to third virtual machines executed by the hypervisor in the processor 175.

The audio output device 185 can convert an electrical signal from the signal processing device 170 into an audio signal, and can output the audio signal. For example, the audio output device 185 can include a speaker.

The power supply 190 can supply power necessary to operate components under control of the signal processing device 170. In particular, the power supply 190 can receive power from a battery in the vehicle.

The signal processing device 170 can control overall operation of each device in the display apparatus 100 for vehicle.

For example, the signal processing device 170 can include a processor 175 configured to perform signal processing for the displays 180a and 180b.

The processor 175 can execute the first to third virtual machines 520 to 540 on the hypervisor 505 (see FIG. 10) in the processor 175.

Among the first to third virtual machines 520 to 540 (see FIG. 10), the first virtual machine 520 can be called a server virtual machine, and the second and third virtual machines 530 and 540 can be called guest virtual machines.

The second virtual machine 530 can be operated for the first display 180a, and the third virtual machine 540 can be operated for the second display 180b.

For example, the first virtual machine 520 in the processor 175 can receive sensor data from the plurality of sensor devices, such as vehicle sensor data, position information data, camera image data, audio data, or touch input data, and can process and output the received sensor data.

As described above, the first virtual machine 520 can process most of the data, whereby 1:N data sharing can be achieved.

As another example, the first virtual machine 520 can directly receive and process controlled area network (CAN) communication data, audio data, radio data, USB data, and wireless communication data for the second and third virtual machines 530 and 540.

The first virtual machine 520 can transmit the processed data to the second and third virtual machines 530 and 540.

Consequently, only the first virtual machine 520, among the first to third virtual machines 520 to 540, can receive sensor data from the plurality of sensor devices, communication data, or external input data, and can perform signal processing, whereby load in signal processing by the other virtual machines can be reduced and 1:N data communication can be achieved, and therefore synchronization at the time of data sharing can be achieved.

In some implementations, the first virtual machine 520 can be configured to write data in the shared memory 508, whereby the second virtual machine 530 and the third virtual machine 540 share the same data.

For example, the first virtual machine 520 can be configured to write vehicle sensor data, the position information data, the camera image data, or the touch input data in the shared memory 508, whereby the second virtual machine 530 and the third virtual machine 540 share the same data. Consequently, 1:N data sharing can be achieved.

Eventually, the first virtual machine 520 can process most of the data, whereby 1:N data sharing can be achieved.

In some implementations, the first virtual machine 520 in the processor 175 can be configured to set the shared memory 508 based on the hypervisor 505 to transmit the same data to the second virtual machine 530 and the third virtual machine 540.

For example, the first virtual machine 520 in the processor 175 can transmit the same data to the second virtual machine 530 and the third virtual machine 540 in a synchronized state using the shared memory 508 based on the hypervisor 505. Consequently, the plurality of displays 180a and 180b in the vehicle can display the same images in a synchronized state.

In some implementations, the signal processing device 170 can process various signals, such as an audio signal, an image signal, and a data signal. For example, the signal processing device 170 can be implemented in the form of a system on chip (SOC).

FIG. 9 is a diagram illustrating an example of a system driven in a signal processing device.

Referring to the figure, FIG. 9 is a diagram illustrating that virtual machines can be used for the cluster display 180a and the AVN display 180b.

The system 400 driven in the signal processing device of FIG. 9 illustrates that a cluster virtual machine 430 and an AVN virtual machine 440 can be executed through a hypervisor 405 in the processor 175.

In some implementations, the system 400 driven in the signal processing device of FIG. 9 illustrates that a legacy virtual machine 410 can also be executed on the hypervisor 405 in the processor 175.

The legacy virtual machine 410 can include an interface 412 for data communication with the memory 140 and an interface 413 for Ethernet communication.

In some implementations, the cluster virtual machine 430 can include an interface 431 for CAN communication, an interface 432 for communication with the interface 412 of the legacy virtual machine 410, and an interface 433 for communication with the interface 413 of the legacy virtual machine 410.

In some implementations, the AVN virtual machine 440 can include an interface 441 for input and output of audio data, radio data, USB data, and wireless communication data, an interface 442 for communication with the interface 412 of the legacy virtual machine 410, and an interface 443 for communication with the interface 413 of the legacy virtual machine 410.

In the system 400, there may be a disadvantage in that CAN communication data are input and output only in the cluster virtual machine 430, whereby the CAN communication data cannot be utilized in the AVN virtual machine 440.

Also, in the system 400 of FIG. 9, there may be a disadvantage in that audio data, radio data, USB data, and wireless communication data are input and output only in the AVN virtual machine 440, whereby these data cannot be utilized in the cluster virtual machine 430.

In addition, in some cases, there may be a disadvantage in that the cluster virtual machine 430 and the AVN virtual machine 440 must include the interfaces 431 and 432 and the interfaces 441 and 442, respectively, for memory data and Ethernet communication data input and output in the legacy virtual machine 410.

Therefore, the present disclosure proposes a scheme for improving the system of FIG. 9. For example, virtual machines can be classified into a server virtual machine and guest virtual machines for inputting and outputting various memory data and communication data not in the guest virtual machines but in the server virtual machine. This will be described with reference to FIG. 10 and subsequent figures.

FIG. 10 is a diagram illustrating another example of a system driven in a signal processing device.

Referring to the figure, the system 500 of FIG. 10 illustrates that the first virtual machine 520, which is a server virtual machine, the second virtual machine 530, which is a guest virtual machine, and the third virtual machine 540, which is a guest virtual machine, can be executed on the hypervisor 505 in the processor 175 of the signal processing device 170.

The second virtual machine 530 can be a virtual machine for the cluster display 180a, and the third virtual machine 540 can be a virtual machine for the AVN display 180b.

For example, the second virtual machine 530 and the third virtual machine 540 can be operated for image rendering of the cluster display 180a and the AVN display 180b, respectively.

In some implementations, the system 500 driven in the signal processing device 170 of FIG. 10 illustrates that a legacy virtual machine 510 can also be executed on the hypervisor 505 in the processor 175.

The legacy virtual machine 510 can include an interface 511 for data communication with the memory 140 and Ethernet communication with the plurality of communication modules EM1 to EM4.

In some implementations, the legacy virtual machine 510 can further include a virtual input and output device backend (virtio-backend) interface 512 for data communication with the second and third virtual machines 530 and 540.

The first virtual machine 520 can include an interface 521 for input and output of audio data, radio data, USB data, and wireless communication data and an input and output server interface 522 for data communication with the guest virtual machines.

For example, the first virtual machine 520, which is a server virtual machine, can provide inputs/outputs (I/O) difficult to virtualize with standard virtualization technology (VirtIO) to a plurality of guest virtual machines, such as the second and third virtual machines 530 and 540.

In some implementations, the first virtual machine 520, which is a server virtual machine, can control radio data and audio data at a supervisor level, and can provide the data to a plurality of guest virtual machines, such as the second and third virtual machines 530 and 540.

In some implementations, the first virtual machine 520, which is a server virtual machine, can process vehicle data, sensor data, and surroundings-of-vehicle information, and can provide the processed data or information to a plurality of guest virtual machines, such as the second and third virtual machines 530 and 540.

In some implementations, the first virtual machine 520 can provide supervisory services, such as processing of vehicle data and audio routing management.

Next, the second virtual machine 530 can include an input and output client interface 532 for data communication with the first virtual machine 520 and APIs 533 configured to control the input and output client interface 532.

In addition, the second virtual machine 530 can include a virtio-backend interface 531 for data communication with the legacy virtual machine 510.

The second virtual machine 530 can receive memory data by communication with the memory 140 and Ethernet data by Ethernet communication from the virtio-backend interface 512 of the legacy virtual machine 510 through the virtio-backend interface 531.

Next, the third virtual machine 540 can include an input and output client interface 542 for data communication with the first virtual machine 520 and APIs 543 configured to control the input and output client interface 542.

In addition, the third virtual machine 540 can include a virtio-backend interface 541 for data communication with the legacy virtual machine 510.

The third virtual machine 540 can receive memory data by communication with the memory 140 and Ethernet data by Ethernet communication from the virtio-backend interface 512 of the legacy virtual machine 510 through the virtio-backend interface 541.

In some implementations, the legacy virtual machine 510 can be provided in the first virtual machine 520.

In the system 500, CAN communication data or Ethernet data from the plurality of communication modules EM1 to EM4 can be input and output only in the first virtual machine 520, but can be provided to a plurality of guest virtual machines, such as the second and third virtual machines 530 and 540, through data processing in the first virtual machine 520. Consequently, 1:N data communication by processing of the first virtual machine 520 can be achieved.

Also, in the system 500 of FIG. 10, audio data, radio data, USB data, and wireless communication data can be input and output only in the first virtual machine 520, but can be provided to a plurality of guest virtual machines, such as the second and third virtual machines 530 and 540, through data processing in the first virtual machine 520. Consequently, 1:N data communication by processing of the first virtual machine 520 can be achieved.

In some implementations, in the system 500 of FIG. 10, the second and third virtual machines 530 and 540 can be operated based on different operating systems.

For example, the second virtual machine 530 can be operated based on a Linux OS, and the third virtual machine 540 can be operated based on a Web OS.

In the first virtual machine 520, the shared memory 508 based on the hypervisor 505 can be set for data sharing, even though the second and third virtual machines 530 and 540 are operated based on different operating systems. Even though the second and third virtual machines 530 and 540 are operated based on different operating systems, therefore, the same data or the same images can be shared in a synchronized state. Eventually, the plurality of displays 180a and 180b can display the same data or the same images in a synchronized state.

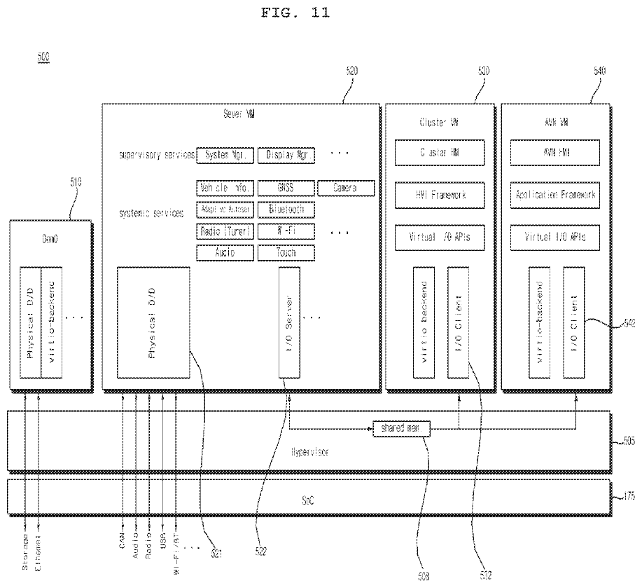

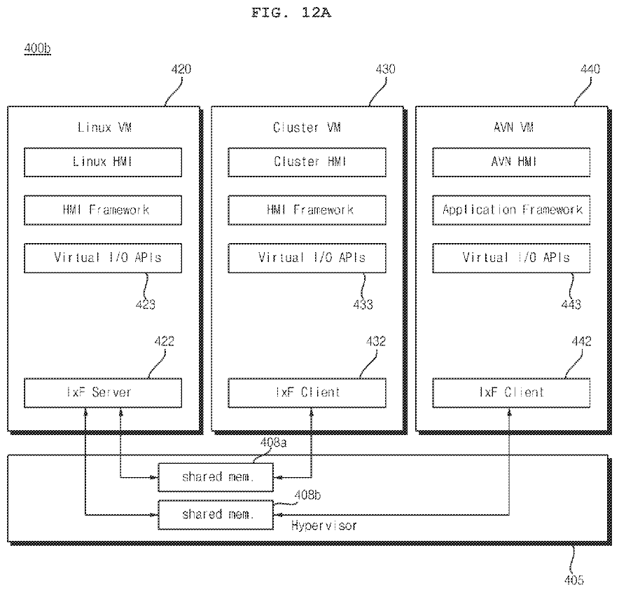

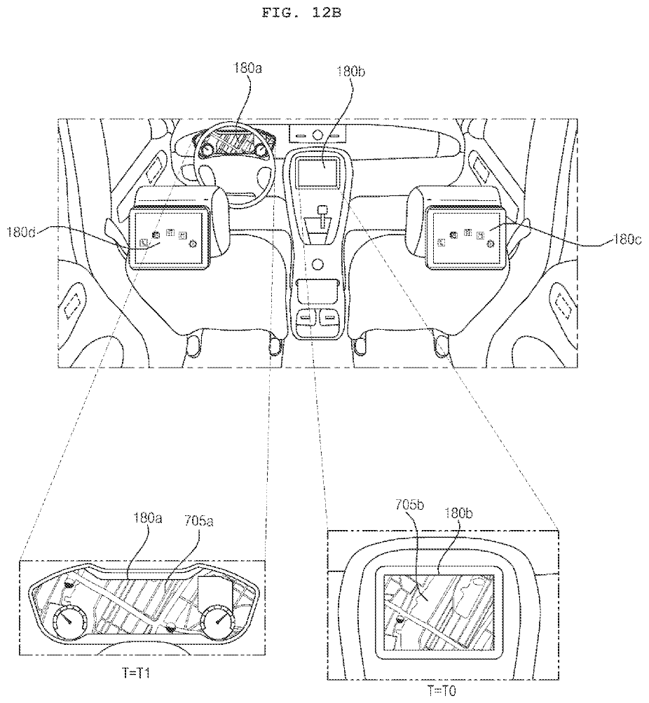

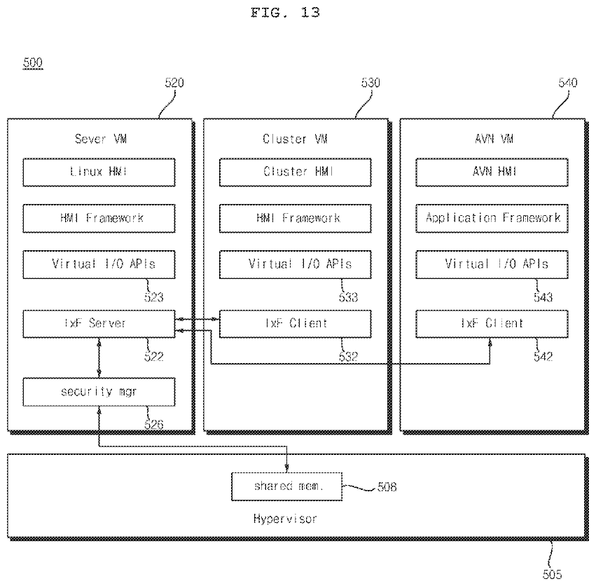

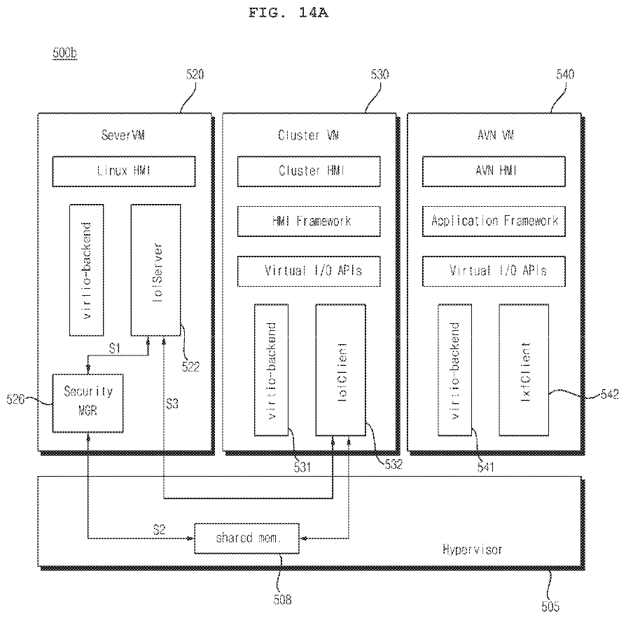

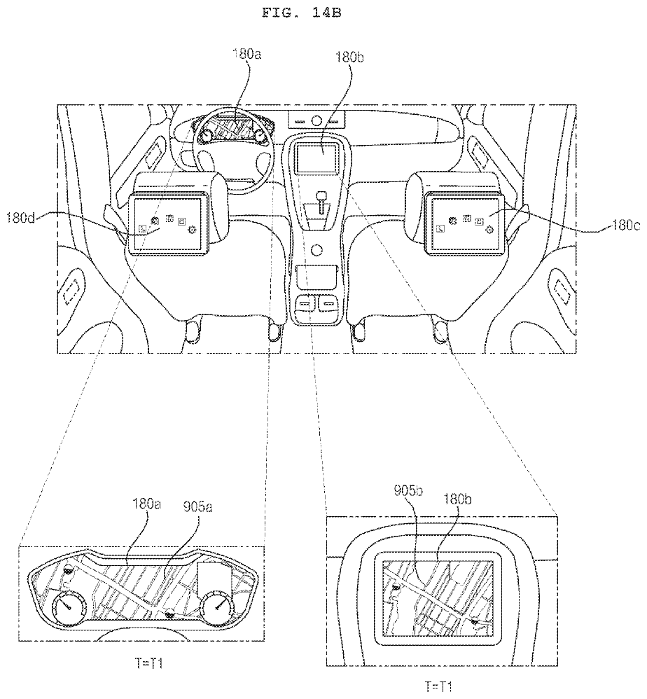

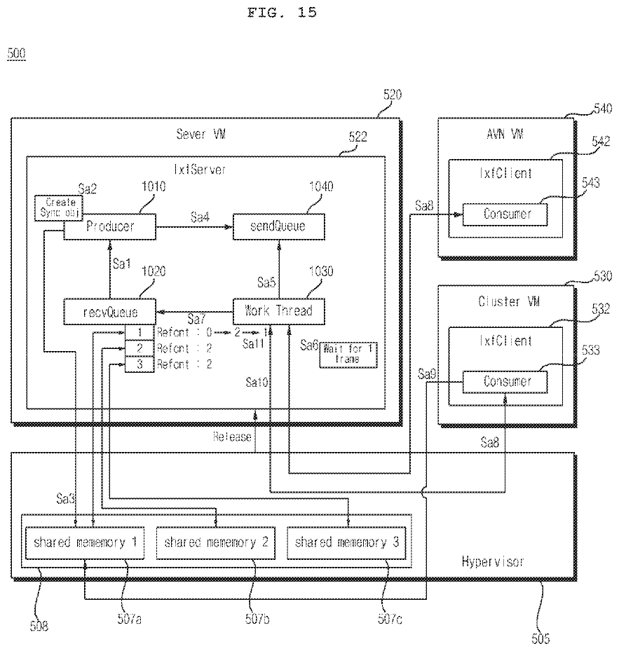

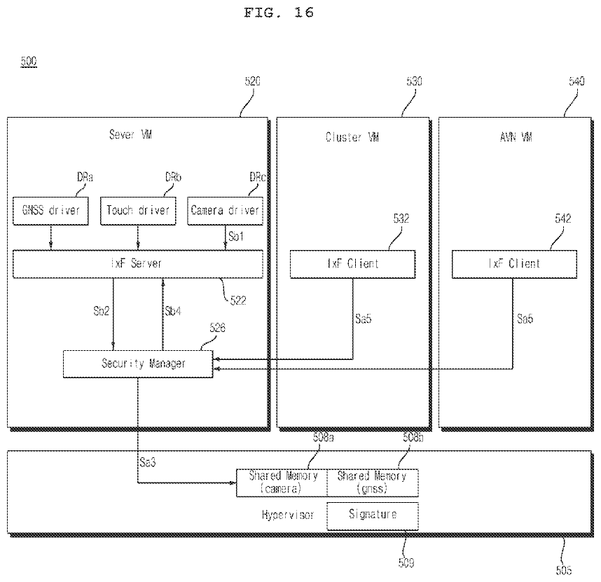

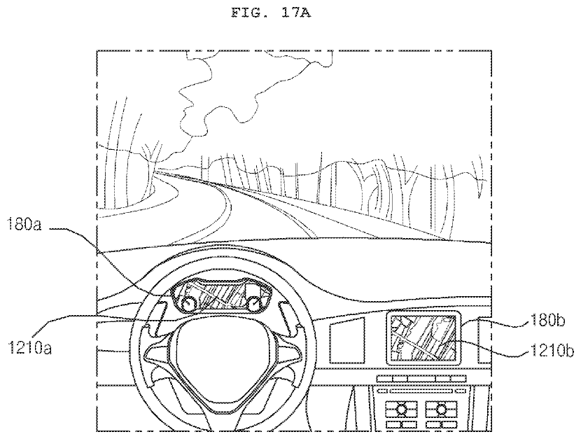

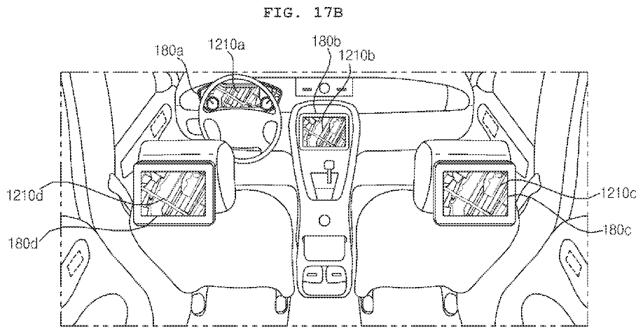

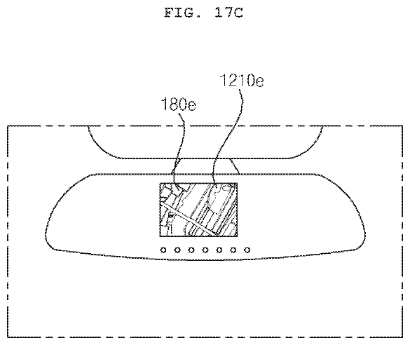

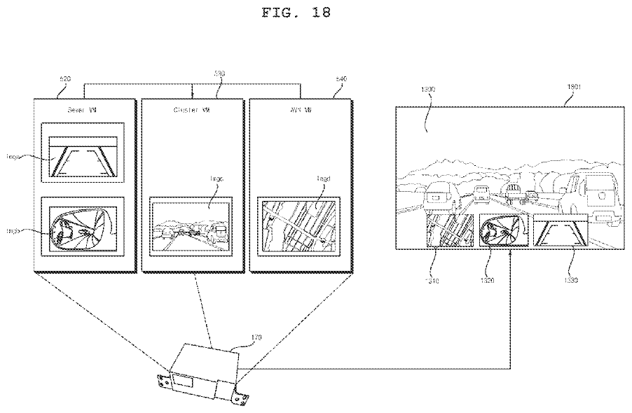

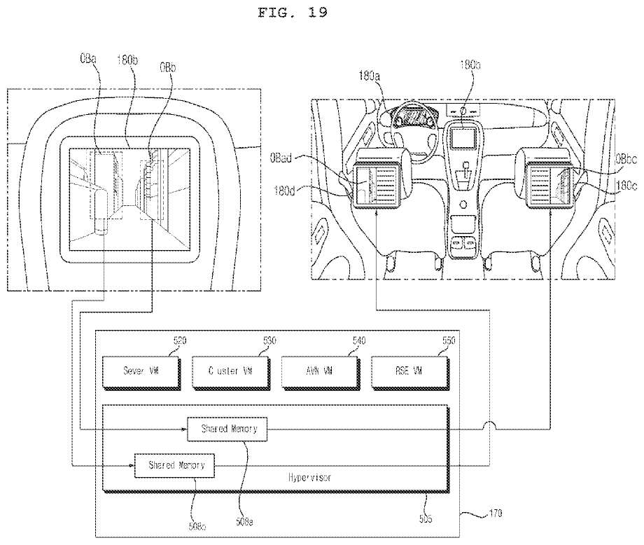

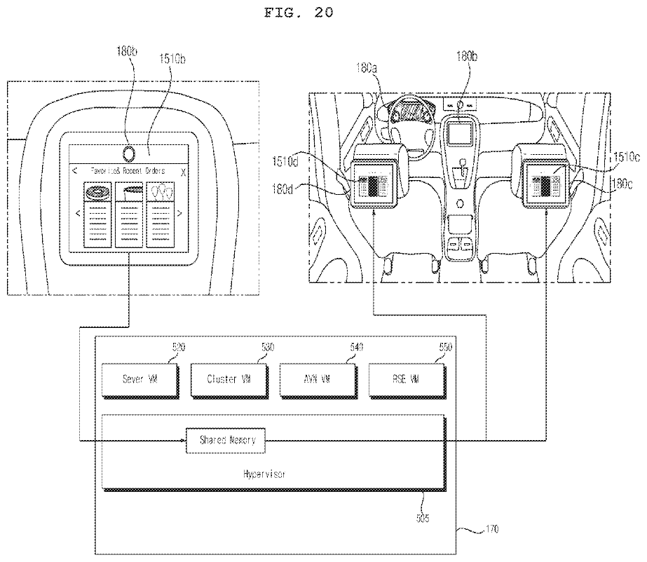

FIG. 11 is a diagram referred to in the description of operation of the system driven in the signal processing device, and FIGS. 12A-B, 13, 14A-B, 15, 16, 17A-C, 18, 19, and to 20 are diagrams referred to in the description of FIG. 10 or 11.

First, in the system 500 of FIG. 11, the processor 175 in the signal processing device 170 can execute the first to third virtual machines 520 to 540 on the hypervisor 505 in the processor 175, and the first virtual machine 520 in the processor 175 can be configured to set the shared memory 508 based on the hypervisor 505 for transmission of the same data to the second and third virtual machines 530 and 540.

For example, the same image data can be illustrated as the same data. Consequently, the plurality of displays 180a and 180b in the vehicle can display the same images in a synchronized state.

In some implementations, in the system 500 of FIG. 11, the processor 175 in the signal processing device 170 can execute the first to third virtual machines 520 to 540 on the hypervisor 505 in the processor 175, and the first virtual machine 520 in the processor 175 can transmit the same data to the second and third virtual machines 530 and 540 in a synchronized state using the shared memory 508 based on the hypervisor 505.

For example, CAN communication data, audio data, radio data, USB data, wireless communication data, position information data, or touch data can be illustrated as the same data. Consequently, the plurality of displays 180a and 180b in the vehicle can display the same data in a synchronized state.

In some implementations, the first virtual machine 520 in the processor 175 can receive position information data variable due to movement from any one of the plurality of communication modules, can process the position information data, and can provide the processed position information data to the second virtual machine 530 or the third virtual machine 540. Consequently, not 1:1 data communication but 1:N data communication using the shared memory can be performed between the virtual machines.

In some implementations, the second virtual machine 530 and the third virtual machine 540 can be driven by different operating systems. Even though the plurality of virtual machines is driven by different operating systems, therefore, it is possible to perform high-speed data communication.

In some implementations, the legacy virtual machine 510 can transmit memory data from the memory 140 and Ethernet data by Ethernet communication with the plurality of communication modules EM1 to EM4 to the second and third virtual machines 530 and 540 in a synchronized state using the shared memory 508 based on the hypervisor 505. For example, it is possible to perform 1:N data communication with respect to the memory data or the Ethernet data, whereby it is possible to transmit the same data in a synchronized state.

FIG. 12A illustrates that three virtual machines 420, 430, and 440 can be operated in a system 400b.

Referring to the figure, the first virtual machine 420, which is a Linux-based virtual machine, can include an input and output server interface 422 for data transmission, and the second virtual machine 430 and the third virtual machine 440 can include input and output client interfaces 432 and 442 for data communication with the input and output server interface 422, respectively.

In some implementations, the first virtual machine 420 must set a first shared memory 408a in a hypervisor 405 to transmit first data to the second virtual machine 430, and the first virtual machine 420 must set a second shared memory 408b different from the first shared memory 408a in the hypervisor 405 to transmit the same first data to the third virtual machine 440.

In the case in which the same first data are transmitted, there may be a disadvantage in that resources are wasted and synchronization may not be easy in the case in which an additional shared memory is used, as shown in FIG. 12A.

FIG. 12B illustrates that, by the system 400b of FIG. 12A, the second virtual machine 430 can control the first display 180a to display image data received through the first shared memory 408a, and the third virtual machine 440 can control the second display 180b to display image data received through the second shared memory 408b.

FIG. 12B illustrates that an image 705a displayed on the first display 180a and an image 705b displayed on the second display 180b may not be synchronized with each other and that the image 705b displayed on the second display 180b corresponds to a more previous frame than the image 705a displayed on the first display 180a.

In response to the first virtual machine 420 transiting the same image data, as described above, synchronization cannot be performed at the time of display of the image, as shown in FIG. 12B, in the case in which an additional shared memory is used, as shown in FIG. 12A.

In order to solve this problem, the present disclosure proposes a scheme for assigning a single shared memory at the time of transmission of the same data. Consequently, 1:N data communication can be performed, whereby synchronized data transmission can be achieved.

FIG. 13 illustrates that the first to third virtual machines 520 to 540 can be executed on the hypervisor 505 in the processor 175 of the system 500 and that the first virtual machine 520 in the processor 175 can be configured to set the shared memory 508 based on the hypervisor 505 to transmit the same data to the second virtual machine 530 and the third virtual machine 540.

Consequently, the first display 180a and the second display 180b in the vehicle can display the same data or the same images in a synchronized state.

In some implementations, high-speed data communication can be performed between the plurality of virtual machines. Furthermore, high-speed data communication can be performed even though the plurality of virtual machines is driven by different operating systems.

In some implementations, the first virtual machine 520 in the processor 175 may not allocate memories corresponding in number to the virtual machines but may use a single shared memory 508, not memory allocation when transmitting the data processed by the first virtual machine 520 to another virtual machine. Consequently, 1:N data communication using the shared memory 508, not 1:1 data communication, can be performed between the virtual machines.

In some implementations, the first virtual machine 520 in the processor 175 can include an input and output server interface 522 and a security manager 526.

In some implementations, the second virtual machine 530 and the third virtual machine 540 can include input and output client interfaces 532 and 542, respectively. Consequently, high-speed data communication between the plurality of virtual machines can be performed using the input and output server interface 522 and the input and output client interfaces 532 and 542.

The input and output server interface 522 in the first virtual machine 520 can receive requests for transmission of the same data from the input and output client interfaces 532 and 542 in the second virtual machine 530 and the third virtual machine 540, and can transmit shared data to the shared memory 508 through the security manager 526 based thereon.

FIG. 14A is a diagram illustrating transmission of shared data in more detail.

Referring to the figure, to transmit shared data, the input and output server interface 522 in the first virtual machine 520 can transmit a request for allocation of the shared memory 508 to the security manager 526 (S1).

Subsequently, the security manager 526 can allocate the shared memory 508 using the hypervisor 505 (S2), and can write shared data in the shared memory 508.

In some implementations, the input and output client interfaces 532 and 542 can transmit a request for connection to the input and output server interface 522 after allocation of the shared memory 508 (S3).

In some implementations, the input and output server interface 522 transmits information regarding shared memory 508 including key data to the input and output client interfaces 532 and 542 after allocation of the shared memory 508 (S4). In some implementations, the key data can be private key data for data access.

In some implementations, the first virtual machine 520 in the processor 175 can transmit information regarding the shared memory 508 to the second virtual machine 530 and the third virtual machine 540 after setting of the shared memory 508.

The input and output client interfaces 532 and 542 can access the shared memory 508 based on the received key data (S5), and can copy the shared data from the shared memory 508.

Consequently, the second virtual machine 530 and the third virtual machine 540 can access the shared memory 508, and can eventually share the shared data.

For example, in the case in which the shared data are image data, the second virtual machine 530 and the third virtual machine 540 can share the image data, and eventually the plurality of displays 180a and 180b in the vehicle can display the same shared images in a synchronized state.

FIG. 14B illustrates that, by the system 500b of FIG. 14A, the second virtual machine 530 can control the first display 180a to display image data received through the shared memory 508, and the third virtual machine 540 can control the second display 180b to display image data received through the shared memory 508.

FIG. 14B illustrates that an image 905 displayed on the first display 180a and an image 905 displayed on the second display 180b can be synchronized, whereby the same images 905a and 905b are displayed at the time of T1.

For example, image data processed by the first virtual machine 520 in the processor 175 are transmitted to the second virtual machine 530 and the third virtual machine 540 through the shared memory 508, and the first image 905 displayed on the first display 180a and the second image 905 displayed on the second display 180b based on the image data can be the same. Consequently, the plurality of displays 180a and 180b in the vehicle can display the same images in a synchronized state. In addition, high-speed data communication between the plurality of virtual machines can be performed.

FIG. 15 is a diagram illustrating an example of the output server interface 522 of FIG. 13 in detail.

Referring to the figure, a plurality of buffers 507a, 507b, and 507c can be set in the shared memory 508.

In some implementations, the input and output client interfaces 532 and 542 in the second virtual machine 530 and the third virtual machine 540 can include consumers 533 and 543, respectively.

In some implementations, the input and output server interface 522 in the first virtual machine 520 can include a producer 1010 configured to generate a synchronization object for graphical synchronization, a recvQueue 1020 configured to manage, particularly receive, a queue, a WorkThread 1030 configured to manage a queue and to control operation of the queue, and a sendQueue 1040 configured to manage, particularly transmit, a queue.

First, the producer 1010 can be configured to receive information regarding the index of an empty index, among the plurality of buffers 507a, 507b, and 507c in the shared memory 508, from the recvQueue 1020 (Sa1). For example, in the case in which the first buffer 507a, among the plurality of buffers 507a, 507b, and 507c, is empty, information regarding the first buffer 507a can be received (Sa1).

In particular, the producer 1010 can receive information regarding the first buffer 507a having a reference count refcnt of 0 from the recvQueue 1020.

Next, the producer 1010 can generate a synchronization object for graphical synchronization to perform writing in the first buffer 507a (Sa2).

Next, the producer 1010 can write data about the generated synchronization object in the first buffer 507a in the shared memory 508 (Sa3).

Next, the producer 1010 can queue information regarding the first buffer 507a, i.e. a buffer index, to the sendQueue 1040 (Sa4).

Next, in the case in which data are input to the sendQueue 1040, which is periodically monitored, the WorkThread 1030 can sense and receive or read the data (Sa5).

For example, in the case in which information regarding the first buffer 507a is input to the sendQueue 1040, which is monitored, the WorkThread 1030 can receive the information.

In some implementations, the WorkThread 1030 waits until a frame about the generated synchronization object is completely drawn (Sa6).

Next, the WorkThread 1030 can increase the reference count refcnt of the buffer corresponding to the first buffer 507a by the number of consumers or the number of input and output client interfaces (Sa7).

For example, since the number of consumers 533 and 543 or the number of input and output client interfaces 532 and 542 is two in the figure, the reference count refcnt of the buffer corresponding to the first buffer 507a can be increased from 0 to 2.

Next, the WorkThread 1030 can transmit the buffer index to the consumers 533 and 543 (Sa8). For example, information corresponding to the first buffer 507a can be transmitted (Sa8).

Next, the consumers 533 and 543 can access the first buffer 507a in the shared memory 508 using the received buffer index to copy data (Sa9).

Next, the consumers 533 and 543 can return the buffer index to the producer 1010 or the WorkThread 1030 after completion of data copying (Sa10).

Next, the producer 1010 can reduce the reference count refcnt of the first buffer 507a by 1 based on information or a buffer index received after completion of data copying for each of the consumers 533 and 543.

For example, in the case in which the first consumer 533 completes data copying, the reference count refcnt of the first buffer 507a is reduced from 2 to 1.

Subsequently, in the case in which the second consumer 543 completes data copying, the reference count refcnt of the first buffer 507a is reduced from 1 to 0.

In some implementations, in the case in which the reference count refcnt of the first buffer 507a is 0, the buffer can be used by the producer 1010.

Similarly, first frame data can be shared using the first buffer 507a, then second frame data can be shared using the second buffer 507b, then third frame data can be shared using the third buffer 507c, and then fourth frame data can be shared using the first buffer 507a again.

For example, the input and output server interface 522 can receive information regarding the empty first buffer 507a in the shared memory 508, can write the first data in the first buffer 507a in the shared memory 508, and can transmit buffer information of the first buffer 507a to the input and output client interfaces 532 and 542 in the second virtual machine 530 and the third virtual machine 540.

In particular, the reference count of the first buffer 507a can be changed in a first direction (e.g. the reference count being increased) based on writing of the first data in the first buffer 507a, and in the case in which copying of the first data from the first buffer 507a is completed, the reference count of the first buffer 507a can be changed in a second direction, which is opposite the first direction, (e.g. the reference count being decreased).

For example, the consumers 533 and 543 in the input and output client interfaces 532 and 542 in the second virtual machine 530 and the third virtual machine 540 can change the reference count of the first buffer 507a in the first direction (e.g. the reference count being increased) based on writing of the first data in the first buffer 507a.

In some implementations, in the case in which copying of the first data from the first buffer 507a is completed, the producer 1010 in the input and output server interface 522 in the first virtual machine 520 can change the reference count of the first buffer 507a in the second direction, which is opposite the first direction, (e.g. the reference count being decreased). After completion of copying, therefore, new data can be written in the first buffer 507a.

In some implementations, the first virtual machine 520 can write first frame data to third frame data in the first buffer 507a to the third buffer 507c, respectively, and the input and output client interfaces 532 and 542 in the second virtual machine 530 and the third virtual machine 540 can sequentially copy the first frame data to the third frame data from the first buffer 507a to the third buffer 507c.

In some implementations, after the input and output client interface 542 in the third virtual machine 540 copying the first frame data from the first buffer 507a is completed, the second virtual machine 530 can copy the second frame data from the second buffer 507b. Consequently, synchronization between the second virtual machine 530 and the third virtual machine 540 can be performed at the time of data sharing.

FIG. 16 is a diagram illustrating that various drivers DRa, DRb, and DRc can be provided in the first virtual machine 520.

Referring to the figure, the first virtual machine 520 can include a position information driver DRa configured to process position information, a touch driver DRb configured to process touch input, and a camera driver DRc configured to process an image from the camera.

Consequently, the first virtual machine 520 can set the shared memory based on the hypervisor 505 for each of the position information driver DRa, the touch driver DRb, and the camera driver DRc.

In some implementations, the input and output server interface 522 can set a first shared memory 508a for transmission of image data from the camera driver DRc, and can set a second shared memory 508b for transmission of position information from the position information driver DRa.

In some implementations, key data of the first shared memory 508a and key data of the second shared memory 508b can be transmitted to the second virtual machine 530 and the third virtual machine 540, and the second virtual machine 530 and the third virtual machine 540 can access the first shared memory 508a and the second shared memory 508b based on the key data of the first shared memory 508a and the key data of the second shared memory 508b.

As depicted in FIG. 16, data from the position information driver DRa and data from the camera driver DRc can be shared, and therefore, two shared memories 508a and 508b can be the shared memories based on the hypervisor 505.

Since a shared memory is set for each of different kinds of shared data, as described above, it is possible to prevent data confusion at the time of data sharing and high-speed data communication between the plurality of virtual machines can be performed.

In some implementations, in response to different kinds of shared data being shared, the security manager 526 can generate key data information for data access, and can generate and register virtual machine information, information for each piece of equipment, allocated memory address information, buffer index information, and the generated key data information in the form of a table.

In some implementations, the input and output client interfaces 532 and 542 in the second virtual machine 530 and the third virtual machine 540 can be connected to the security manager 526, can request and receive key data with reference to the table in the security manager 526, and can access a corresponding one of the shared memories using the received key data.

In some implementations, in the case in which data from the camera driver DRc are shared through the first shared memory 508a and in the case in which data from the position information driver DRa are shared through the second shared memory 508b, the virtual machine information in one case and the virtual machine information in the other case can be the same to each other, but the information for each piece of equipment, the allocated memory address information, the buffer index information, and the generated key data information in one case and the information for each piece of equipment, the allocated memory address information, the buffer index information, and the generated key data information in the other case can be different from each other. Consequently, it is possible to prevent data confusion at the time of sharing of different kinds of data and high-speed data communication between the plurality of virtual machines can be performed.

FIG. 17A is a diagram illustrating that the same images 1210a and 1210b can be displayed respectively on the first display 180a and the second display 180b in the vehicle.

For example, in the case in which the second virtual machine 530 is operated for rendering of the first display 180a and the third virtual machine 540 is operated for rendering of the second display 180b, 1:N data communication by the first virtual machine 520 can be performed, whereby synchronized images can be displayed, as shown in the figure.

FIG. 17B is a diagram illustrating that the same images 1210a, 1210b, 1210c, and 1210d can be displayed respectively on the first display 180a, the second display 180b, the third display 180c, and the fourth display 180d in the vehicle.

For example, in the case in which the second virtual machine 530 is operated for rendering of the first display 180a, the third virtual machine 540 is operated for rendering of the second display 180b, the fourth virtual machine is operated for rendering of the third display 180c, and a fifth virtual machine is operated for rendering of the fourth display 180d, 1:N data communication by the first virtual machine 520 can be performed, whereby synchronized images can be displayed, as shown in the figure.

FIG. 17C is a diagram illustrating that a display 180e can be provided on a rear-view mirror in the vehicle to display an image 1210e.

For example, in the case in which FIGS. 17A and 17C are linked to each other, the same images 1210a, 1210b, and 1210e can be displayed respectively on the first display 180a, the second display 180b, and the rear-view mirror display 180e in the vehicle.

In some implementations, in the case in which the second virtual machine 530 is operated for rendering of the first display 180a, the third virtual machine 540 is operated for rendering of the second display 180b, and the fourth virtual machine is operated for rendering of the rear-view mirror display 180e, 1:N data communication by the first virtual machine 520 can be performed, whereby synchronized images can be displayed, as shown in the figure.

As another example, in the case in which FIGS. 17B and 17C are linked to each other, the same images 1210a, 1210b, 1210c, 1210d, and 1210e can be displayed respectively on the first display 180a, the second display 180b, the third display 180c, the fourth display 180d, and the rear-view mirror display 180e in the vehicle.

FIG. 18 is a diagram illustrating that a HUD display 180f can be disposed in the vehicle.

Referring to the figure, the display apparatus 100 for vehicle can include a first display 180a corresponding to an instrument cluster, a second display 180b corresponding to an AVN, and a HUD display 180f.

The signal processing device 170 can be configured to control the third display 180c to display an image generated by combining first image data processed by the first virtual machine 520, second image data processed by the second virtual machine 530, and third image data processed by the third virtual machine 540.

As depicted in FIG. 18, the first virtual machine 520 can process rear-view mirror image data Imga and side mirror image data Imgb, the second virtual machine 530 can process front camera image data Imgc, the third virtual machine 540 can process navigation image data Imgd, and an image generated by combining the four kinds of image data can be displayed on the HUD display 180f, which is a third display.

As depicted in FIG. 18, an image 1300 corresponding to the front camera image data Imgc can be a background, and images 1310, 1320, and 1330 corresponding respectively to the navigation image data Imgd, the side mirror image data Imgb, and the rear-view mirror image data Imga can be displayed together. As a result, synchronized images can be displayed together. Consequently, it is possible for a user to check all images around the vehicle through the HUD display 180f.

FIG. 19 is a diagram illustrating that portions Oba and OBb of an image displayed on the second display 180b can be processed and displayed on the third display 180c and the fourth display 180d, which are RSE displays, in a synchronized state.

As depicted in FIG. 19, a partial image OBad can be displayed on the third display 180c and another partial image OBbd can be displayed on the fourth display 180d in a synchronized state.

FIG. 20 is a diagram illustrating that an image 1510b displayed on the second display 180b can be processed and displayed on the third display 180c and the fourth display 180d, which are RSE displays, in a synchronized state.

As depicted in FIG. 20, the same image 1510c can be displayed on the third display 180c and the same image 1510d can be displayed on the fourth display 180d in a synchronized state.

In some implementations, in the display apparatus 100 for vehicle, the first virtual machine 520 in the signal processing device 170 can receive first touch input on the first display 180a through the second virtual machine 530 and can transmit image data processed based on the first touch input to the second virtual machine 530 and the third virtual machine 540 through the shared memory 508, and the first display 180a and the second display 180b can display the same images corresponding to the first touch input. Consequently, the plurality of displays 180a and 180b in the vehicle can display the same images in a synchronized state.

1-20. (canceled)

21. A vehicle communication device comprising:
a plurality of communication modules configured to be disposed at a plurality of areas of a vehicle and further configured to (i) receive, from a plurality of sensor devices configured to be disposed at the plurality of areas of the vehicle, one or more signals and (ii) transmit one or more signals of the received one or more signals to an outside of the plurality of communication modules; and
a signal processing device configured to be disposed between the plurality of areas of the vehicle and further configured to receive a signal from the plurality of communication modules and perform signal processing, wherein each communication module among the plurality of communication modules comprises:
a first connector configured to receive one or more signals from one or more devices among the plurality of sensor devices at a first communication speed,
a second connector configured to communicate with the signal processing device at a second communication speed greater than the first communication speed, and
a first switch disposed between the first connector and the second connector and configured to perform switching between the first connector and the second connector.

22. The vehicle communication device of claim 21, wherein:
the each communication module further comprises a processor electrically connected to the first switch, and
the processor is configured to process the one or more signals from the sensor devices and transmit the processed one or more signals to the signal processing device via the second connector.

23. The vehicle communication device of claim 21, wherein the each communication module is configured to transmit, to the signal processing device, one or more signals from one or more sensor devices disposed at each area corresponding to the each communication module among the plurality of areas.

24. The vehicle communication device of claim 21, wherein:
the signal processing device comprises a second switch configured to be operated based on the second communication speed,
the second switch is configured to be operated as a master device, and
the first switch in the each communication module is configured to be operated as a slave device based on the first communication speed or the second communication speed.

25. The vehicle communication device of claim 21, wherein the first connector is configured to perform serial communication, and the second connector is configured to perform parallel communication.

26. The vehicle communication device of claim 21, wherein the plurality of communication modules comprise:
a first communication module configured to receive, from one or more first sensor devices disposed in a first area among the plurality of areas, one or more first signals and transmit the one or more first signals to the signal processing device, and
a second communication module configured to receive, from one or more second sensor devices disposed in a second area among the plurality of areas, one or more second signals and transmit the one or more second signals to the signal processing device.

27. The vehicle communication device of claim 21, wherein the plurality of communication modules comprise:
a first communication module configured to receive, from one or more first sensor devices disposed in a first area among the plurality of areas, one or more first signals and transmit the one or more first signals to the signal processing device,
a second communication module configured to receive, from one or more second sensor devices disposed in a second area among the plurality of areas, one or more second signals and transmit the one or more second signals to the signal processing device,
a third communication module configured to receive, from one or more third sensor devices disposed in a third area among the plurality of areas, one or more third signals and transmit the one or more third signals to the signal processing device, and
a fourth communication module configured to receive, from one or more fourth sensor devices disposed in a fourth area among the plurality of areas, one or more fourth signals and transmit the one or more fourth signals to the signal processing device.

28. The vehicle communication device of claim 21, wherein the each communication module is configured to output a vehicle control signal for controlling a door and a seat of the vehicle while the vehicle travels.

29. The vehicle communication device of claim 21, wherein each of the plurality of sensor devices comprises a camera, a lidar, a radar, or a position sensor.

30. The vehicle communication device of claim 21, wherein:
the signal processing device comprises a processor configured to perform signal processing for a first display and a second display that are configured to be located in the vehicle,
the processor is configured to execute first, second, and third virtual machines on a hypervisor in the processor,
the second virtual machine is configured to be operated for the first display,
the third virtual machine is configured to be operated for the second display, and
the first virtual machine is configured to set a shared memory based on the hypervisor for transmission of data to the second virtual machine and the third virtual machine.

31. The vehicle communication device of claim 30, wherein the first virtual machine is configured to set the shared memory based on the hypervisor for transmission of same data to the second virtual machine and the third virtual machine.

32. The vehicle communication device of claim 30, wherein the first virtual machine is configured to transmit, to the second virtual machine and the third virtual machine, information regarding the shared memory comprising key data for data access after setting the shared memory.

33. The vehicle communication device of claim 30, wherein:
the first virtual machine comprises an input and output server interface and a security manager, and
each of the second virtual machine and the third virtual machine comprises an input and output client interface.

34. The vehicle communication device of claim 33, wherein:
the security manager is configured to allocate the shared memory, and
the input and output client interface is configured to transmit a request for connection to the input and output server interface after allocation of the shared memory.

35. The vehicle communication device of claim 33, wherein:
the input and output server interface is configured to transmit information regarding the shared memory comprising key data for data access to the input and output client interface after allocation of the shared memory, and
the input and output client interface is configured to access the shared memory based on the key data.

36. The vehicle communication device of claim 33, wherein the input and output server interface is configured to:
receive information regarding a first buffer in the shared memory,
write, based on the first buffer being empty according to the received information regarding the first buffer, first data in the first buffer in the shared memory, and
transmit buffer information of the first buffer to the input and output client interfaces in the second virtual machine and the third virtual machine.

37. The vehicle communication device of claim 30, wherein the first virtual machine is configured to:
receive vehicle sensor data, position information data, or camera image data from at least one of the plurality of communication modules,
process the received data, and
provide the processed data to the second virtual machine or the third virtual machine.

38. The vehicle communication device of claim 30, wherein the first virtual machine is configured to:
receive wheel speed sensor data of the vehicle from at least one of the plurality of communication modules,
process the received wheel speed sensor data, and
transmit the processed wheel speed sensor data to at least one of the second virtual machine or the third virtual machine.

39. A vehicle communication device comprising:
a plurality of communication modules configured to be disposed at a plurality of areas of a vehicle and further configured to receive, from a plurality of sensor devices configured to be disposed at the plurality of areas of the vehicle, one or more signals and transmit one or more signals of the received one or more signals to an outside of the plurality of communication modules, wherein each communication module among the plurality of communication modules comprises:
a first connector configured to receive one or more signals from the plurality of sensor devices at a first communication speed,
a second connector configured to communicate with one of the plurality of communication modules adjacent thereto at a second communication speed greater than the first communication speed; and
a switch disposed between the first connector and the second connector and configured to perform switching between the first connector and the second connector.

40. A display apparatus for a vehicle, the display apparatus comprising:
a first display;
a second display; and
a vehicle communication device comprising (i) a signal processing device that includes a processor configured to perform signal processing for the first display and the second display and (ii) a plurality of communication modules configured to be disposed at a plurality of areas of the vehicle and further configured to receive, from a plurality of sensor devices configured to be disposed at the plurality of areas of the vehicle, one or more signals and transmit one or more signals of the received one or more signals to an outside of the plurality of communication modules,
wherein the signal processing device is configured to be disposed between the plurality of areas and further configured to receive one or more signals from the plurality of communication modules and perform signal processing, and
wherein each communication module among the plurality of communication modules comprises:
a first connector configured to receive one or more signals from one or more sensor devices among the plurality of sensor devices at a first communication speed,
a second connector configured to communicate with the signal processing device at a second communication speed greater than the first communication speed, and
a switch disposed between the first connector and the second connector and configured to perform switching between the first connector and the second connector.
